(19) United States
(12) Patent Application Publication
(10) Pub. No.: US 2022/0180225 A1
(43) Pub. Date: Jun. 9, 2022

(54) DETERMINING A COUNTERFACTUAL EXPLANATION ASSOCIATED WITH A GROUP USING ARTIFICIAL INTELLIGENCE AND MACHINE LEARNING TECHNIQUES

(71) Applicant: Accenture Global Solutions Limited, Dublin (IE)

(72) Inventors: Christophe GUERET, Co. Dublin (IE); Luca COSTABELLO, Co. Kildare (IE); Rory McGRATH, Co. Kildare (IE)

(21) Appl. No.: 17/247,318

(22) Filed: Dec. 7, 2020

(51) Int. Cl. G06N 5/04; G06N 20/00

(52) U.S. Cl. CPC G06N 5/04; G06N 20/00

(57) ABSTRACT

A device may receive data associated with units of a group. A subset of the data, for a unit, may include values for features of the unit and an indication of whether the subset indicates that the unit satisfies a qualification threshold of a qualification model. The device may identify subsets of the data that indicate that a subsets of units do not satisfy the qualification threshold; alter feature values, of the subsets of the units, for a feature to generate revised subsets of the data; and process, based on the qualification model, the revised subsets of the data to obtain counterfactual explanations. The device may determine an impact score associated with the feature based on a quantity of units, of the subset of units, that satisfied the qualification threshold based on the revised subsets of the data; and determine that the impact score satisfies an impact threshold.

### BACKGROUND

A system may be configured to make decisions and/or provide an analysis based on a given set of data. For example, the system may be used to qualify an entity (e.g., an individual, an organization, and/or a platform, among other examples) according to one or more thresholds, requirements, or standards. In such a case, when the system determines that the entity is not qualified, the system can provide a counterfactual explanation that describes a scenario in which the entity would have been qualified.

### SUMMARY

In some implementations, a method includes receiving, by a device, first data associated with a first unit of a group of units, second data associated with a second unit of the group of units, and target data; obtaining, by the device and based on a qualification model, a first counterfactual explanation associated with the first data not satisfying a qualification threshold of the qualification model, and a second counterfactual explanation associated with the second data not satisfying the qualification threshold, wherein the first counterfactual explanation and the second counterfactual explanation are associated with a first feature identified in the first data and the second data; determining, by the device, an impact score associated with the first feature based on the target data, the first counterfactual explanation, and the second counterfactual explanation; determining, by the device, that the impact score does not satisfy an impact threshold; generating, by the device and based on the impact score not satisfying the impact threshold, one or more revised counterfactual explanation constraints of the qualification model; obtaining, by the device and based on the one or more revised counterfactual explanation constraints of the qualification model, a first revised counterfactual explanation and a second revised counterfactual explanation; determining, by the device, a revised impact score based on the target data, the first revised counterfactual explanation, and the second revised counterfactual explanation; determining, by the device, that the revised impact score satisfies the impact threshold; and performing, by the device and based on determining that the revised impact score satisfies the impact threshold, an action associated with the second feature and the group of units.

In some implementations, a device includes one or more memories; and one or more processors, communicatively coupled to the one or more memories, configured to: receive data associated with units of a group, wherein, for a unit, a subset of the data includes values for features of the unit and a counterfactual explanation associated with the unit not satisfying a qualification threshold of a qualification model; determine, based on the data, that a subset of units of the group are associated with a same counterfactual explanation; alter feature values, of the subsets of the units, for a feature that is associated with the counterfactual explanation to generate revised subsets of the data with revised feature values; process, based on the qualification model, the revised subsets of the data to obtain revised counterfactual explanations associated with the subsets of the units; determine an impact score associated with the feature based on a quantity of units, of the subset of units, that satisfy the qualification threshold based on the revised subsets of the data; determine that the impact score satisfies an impact threshold; and provide, to a user device, information identifying that the revised feature values cause the quantity of units to satisfy the qualification threshold of the qualification model.

In some implementations, a non-transitory computer-readable medium storing a set of instructions includes one or more instructions that, when executed by one or more processors of a device, cause the device to: receive data associated with units of a group, wherein, for a unit, a subset of the data includes values for features of the unit and an indication of whether the subset of the data indicates that the unit satisfies a qualification threshold of a qualification model; identify subsets of the data associated with a subset of units of the group that indicate that the subsets of units do not satisfy the qualification threshold according to the qualification model; alter feature values, of the subsets of the units, for a feature to generate revised subsets of the data with revised feature values; process, based on the qualification model, the revised subsets of the data to obtain counterfactual explanations associated with the subsets of the units; determine an impact score associated with the feature based on a quantity of units, of the subset of units, that satisfied the qualification threshold based on the revised subsets of the data; determine that the impact score satisfies an impact threshold; and perform an action associated with the feature and the group.

### BRIEF DESCRIPTION OF THE DRAWINGS

FIGS. 1A-1E are diagrams of an example implementation described herein.

FIG. 2 is a diagram illustrating an example of training and using a machine learning model in connection with generating a counterfactual explanation associated with a group.

FIG. 3 is a diagram of an example environment in which systems and/or methods described herein may be implemented.

FIG. 4 is a diagram of example components of one or more devices of FIGS. 3 and 4.

FIG. 5 is a flowchart of an example process associated with determining a counterfactual explanation associated with a group.

### DETAILED DESCRIPTION

The following detailed description of example implementations refers to the accompanying drawings. The same reference numbers in different drawings may identify the same or similar elements.

Counterfactual explanations can be generated in association with a decision from an automated analysis system (e.g., an automated analysis system configured to indicate whether an individual is qualified to receive a particular service or product). For example, if an individual does not qualify to receive a telecommunication service in a particular unit of a building, a counterfactual explanation may be generated to enable the individual to qualify to receive the telecommunication service.

A counterfactual explanation is generally generated on a case by case or on an individual basis. For example, a counterfactual explanation generated for a first case may be inapplicable to a second case. Similarly, a counterfactual explanation generated for a first individual may be inapplicable to a second individual. In some instances, a counterfactual explanation may be generated for a group (e.g., a group of cases or for a group of individuals). However, such counterfactual explanation is typically applicable to only a portion of the group (e.g., less than a majority of the group). Generating such a counterfactual explanation (that is applicable to only a portion of the group) wastes computing resources, network resources, and/or communication resources that are used to generate the counterfactual explanation because of the limited applicability to the group and/or that are used to generate one or more additional counterfactual explanations for one or more other portions of the group.

Some implementations described herein provide a device that determines a counterfactual explanation that is applicable to a majority of a group based on one or more constraints associated with the group. For example, the device may receive data associated with units of a group. A subset of the data, for a unit, includes values for features of the unit and a counterfactual explanation associated with the unit not satisfying a qualification threshold of a qualification model. The device may determine, based on the data, that a subset of units of the group are associated with a same counterfactual explanation and may alter feature values, of the subsets of the units, for a feature that is associated with the counterfactual explanation to generate revised subsets of the data with revised feature values.

The device may process, based on the qualification model, the revised subsets of the data to obtain revised counterfactual explanations associated with the subsets of the units; and may determine an impact score associated with the feature based on a quantity of units, of the subset of units, that satisfy the qualification threshold based on the revised subsets of the data. The device may determine that the impact score satisfies an impact threshold; and may provide, to a user device, information identifying that the revised feature values cause the quantity of units to satisfy the qualification threshold of the qualification model.

By obtaining revised counterfactual explanations and determining that the impact score satisfies an impact threshold, the device may preserve computing resources, network resources, and/or communication resources that would have otherwise been used to generate a counterfactual explanation (for a group) that is applicable to only a portion of the group and/or that would have otherwise been used to generate one or more additional counterfactual explanations for one or more other portions of the group.

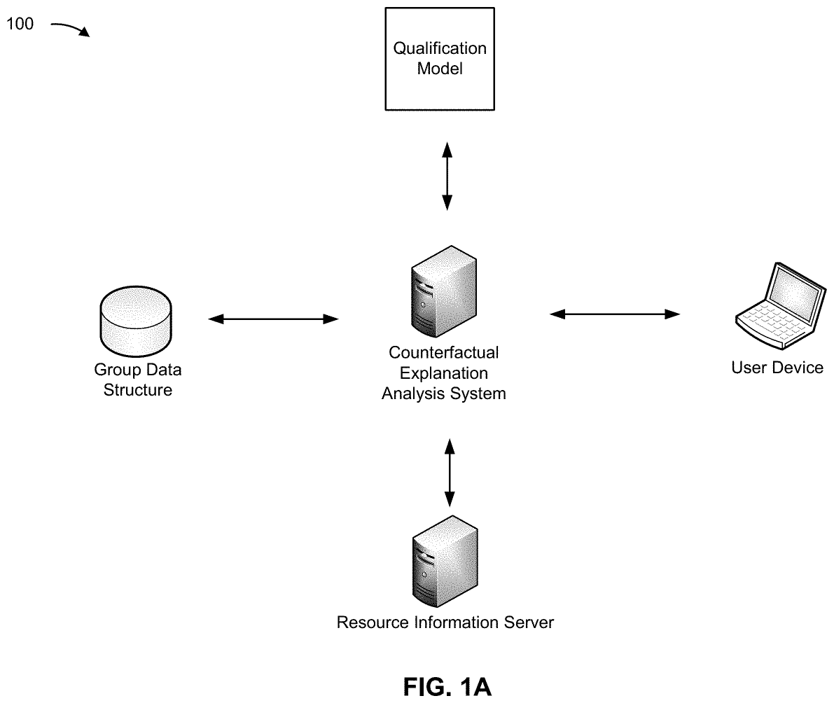

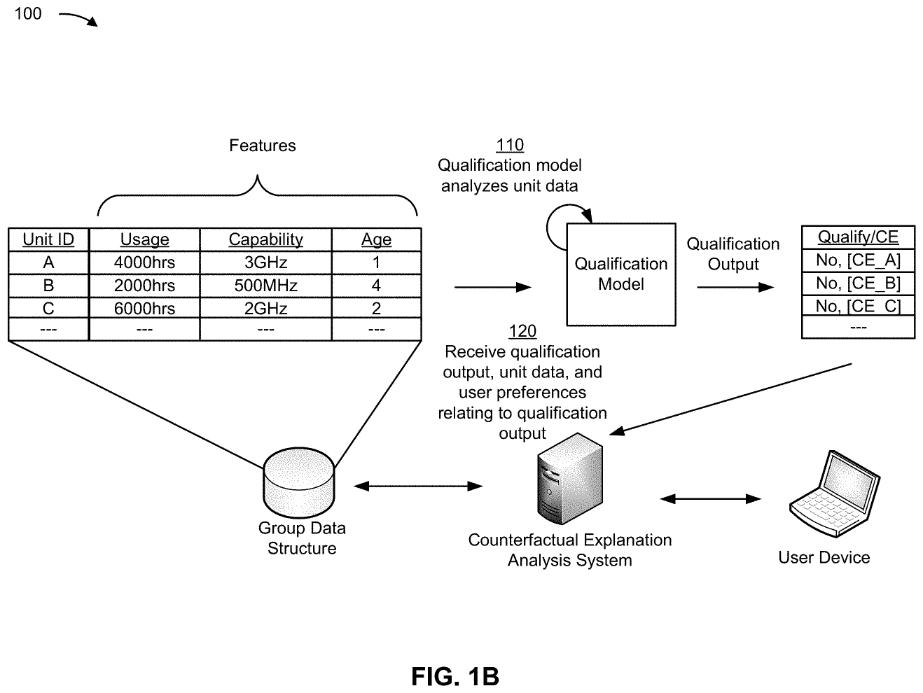

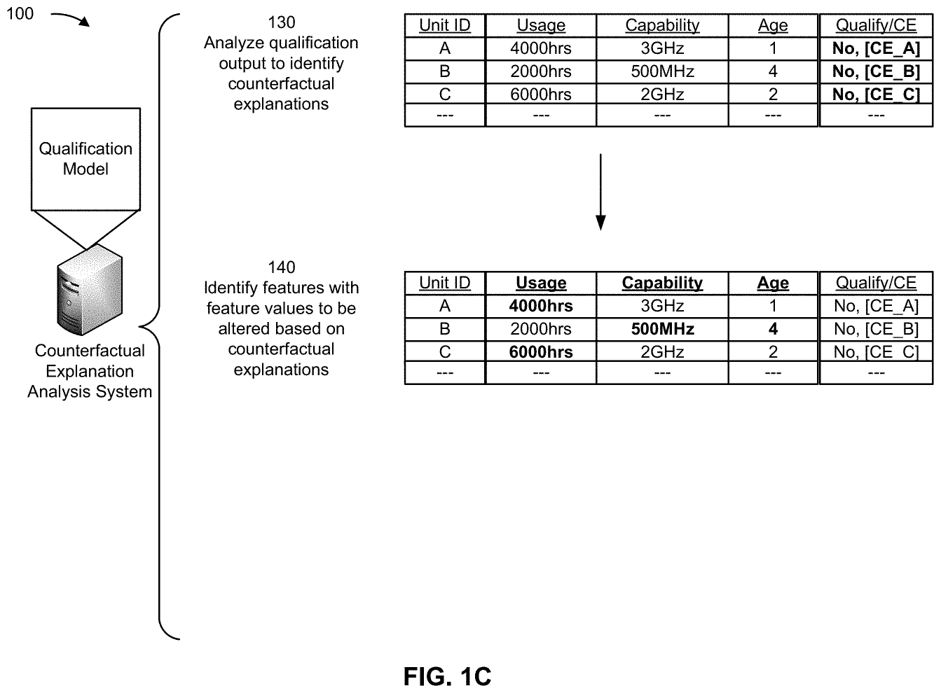

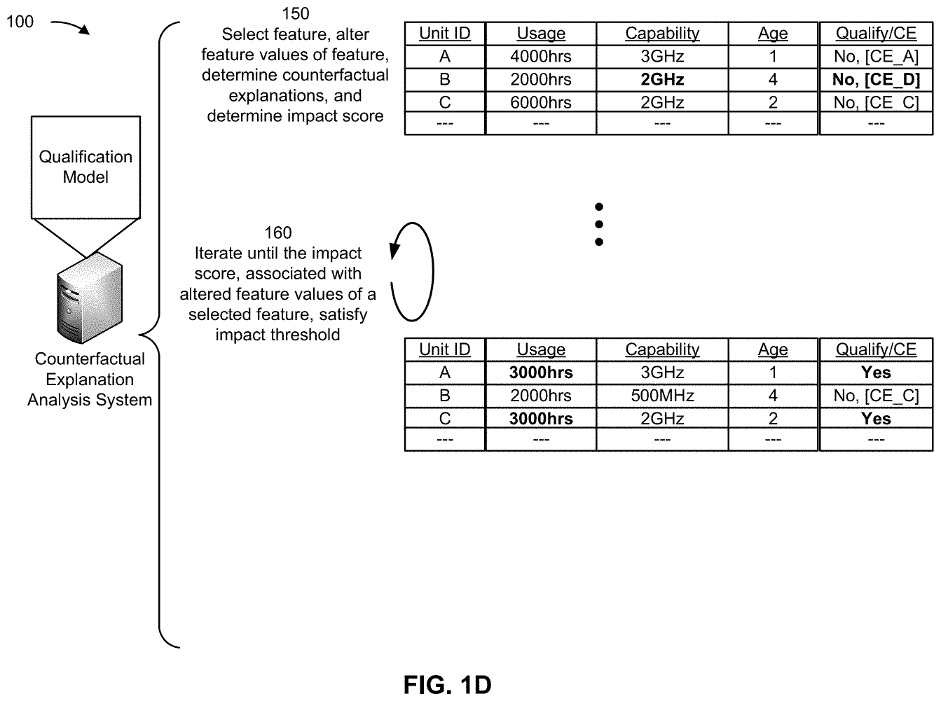

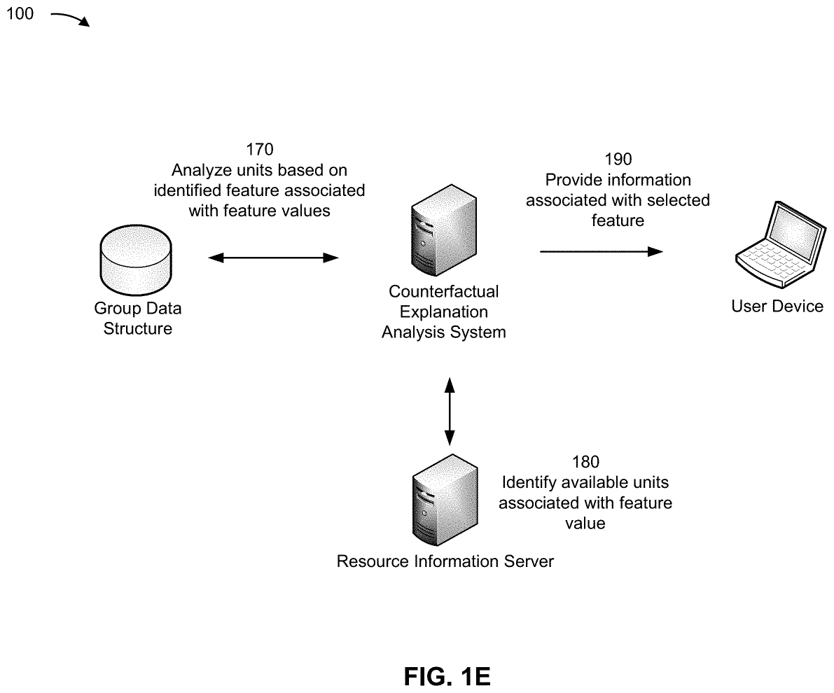

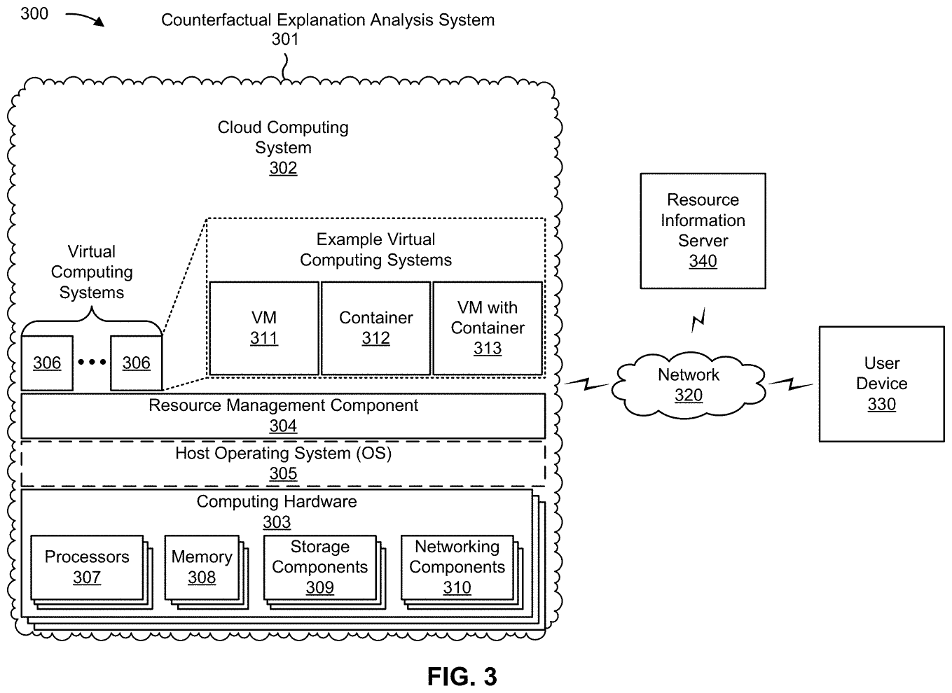

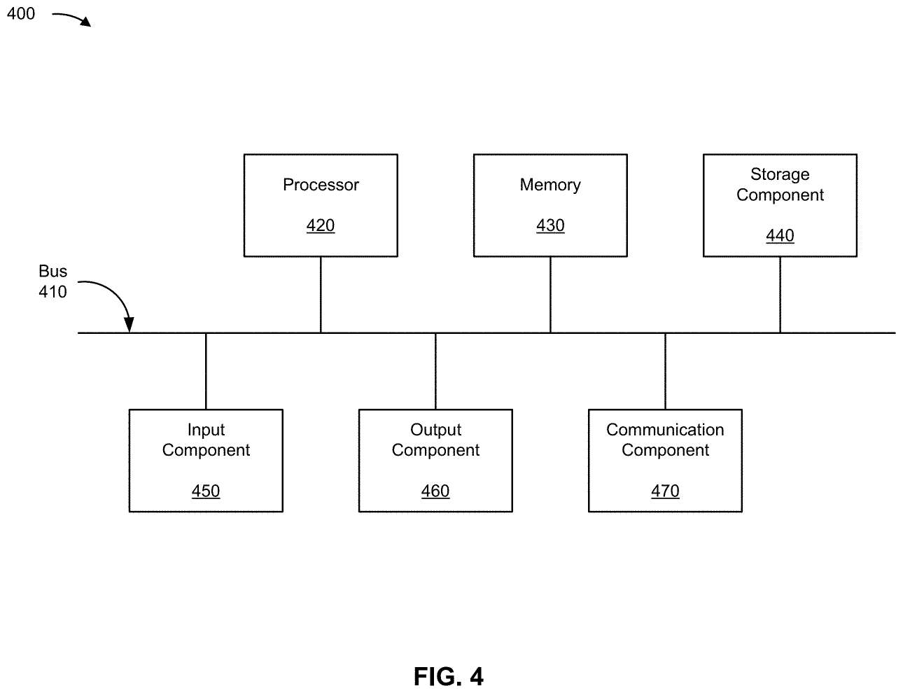

FIGS. 1A-1E are diagrams of an example implementation 100 described herein. Example implementation 100 may be associated with determining a counterfactual explanation associated with a group. As shown in FIG. 1A, example implementation 100 includes a group data structure, a qualification model, a user device, a counterfactual explanation analysis system, and a resource information server. The user device, the counterfactual explanation analysis system, and the resource information server are described in more detail below in connection with FIG. 3 and FIG. 4.

The group data structure may include a data structure (e.g., a database, a table, and/or a linked list) that stores unit data regarding different units that may be organized into one or more groups of units. A unit may include an object, a human, an animal, a plant, an organization, a platform, and/or an another item that may be organized into one or more groups of units (e.g., one or more groups of objects, one or more groups of humans, one or more groups of animals, one or more groups of plants, etc.). The unit data of a unit may include information identifying the unit and information identifying one or more features (e.g., one or more characteristics) of the unit.

In the description to follow and simply as an example, a group of units will generally described as a group of computers. In this regard, a unit will generally be described as a computer (e.g., a laptop computer or a desktop computer) and the one or more features of the item may include one or more features of the computer such as an amount of usage of the computer (e.g., an amount of hours of usage), a capability of the computer (e.g., a processing capability of the computer), and/or an age of the computer. The description herein is not limited to a group of computers or to the features mentioned above but is applicable to any other unit that can be organized as a group (as explained above) and applicable to other features.

The qualification model may include a machine learning model that receives, as input, information identifying one or more units and determines (or predicts) whether the one or more units qualify for an outcome desired for the group of units (e.g., qualify for a service (e.g., a technological service, a transportation service, a financial service, and/or another service), qualify for a product, qualify as being ready to be used, qualify as being in good health, and/or qualify for another desired outcome).

Additionally, or alternatively, the qualification model may determine one or more counterfactual explanations when the one or more units do not qualify for the outcome. In some implementations, the qualification model may be implemented on the counterfactual explanation analysis system. Additionally, or alternatively, the qualification model may be implemented on a device or system different than the counterfactual explanation analysis system.

In the description to follow and simply as an example, the qualification model may predict whether the group of units qualify to be included in a network (e.g., for the purpose of providing networking services). The description herein is not limited to qualifying the group of units to be included in a network as mentioned above but is applicable to qualifying the group of units for another outcome (e.g., qualifying for a service, for a product, and/or another type of outcome).

The user device may include a device (e.g., a computer) that may be configured to transmit requests (e.g., to the counterfactual explanation analysis system) for counterfactual explanations for (or associated with) groups of units (e.g., a first counterfactual explanation for a first group of units, a second counterfactual explanation for a second group of units, and so on). In some implementations, the user device may provide information identifying user preferences (e.g., constraints) that may be used by the counterfactual explanation analysis system to determine the counterfactual explanations for the groups of units, as described in more detail below. As an example, the user preferences (e.g., the constraints) may identify a manner in which the counterfactual explanations are to be determined by the counterfactual explanation analysis system.

The counterfactual explanation analysis system may determine counterfactual explanations for groups of units as explained above. In some implementations, the counterfactual explanation analysis system and/or the qualification model may implement an algorithm that iteratively identifies features of individual units of a group of units, adjusts feature values of the features, and analyzes (or searches) counterfactual explanations determined (e.g., based on the adjusted feature values) for the individuals units until the counterfactual explanation analysis system identifies a counterfactual explanation that is applicable to the group (e.g., a majority of the group of units), as described in more detail below. In some implementations, the feature values may be adjusted based on the user preferences (e.g., the constraints).

The resource information server may provide information regarding availability of other units (associated with the group of units) that may be used to replace one or more units of the group of units, as described in more detail below. For example, the information regarding availability of other units may be stored in a data structure associated with the resource information server.

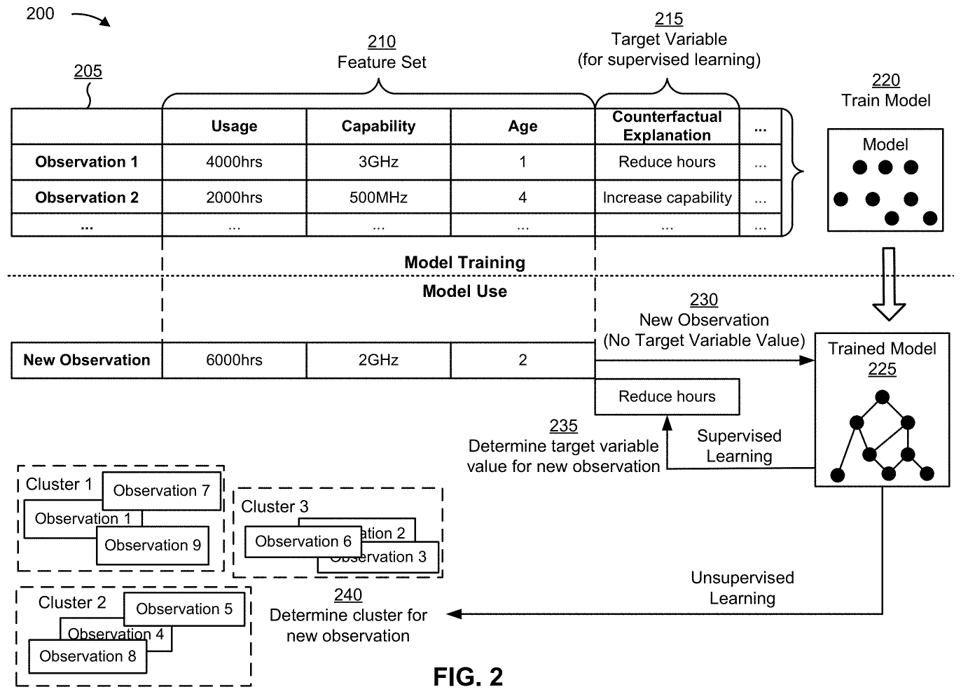

As shown in FIG. 1B, and by reference 110 number, the qualification model may analyze unit data (e.g., regarding a group of units). For example, the qualification model may receive a request to analyze the unit data to determine a qualification of the group of units for an outcome (e.g., qualification of the group of units to be used in a network). The qualification model may generate a qualification output as a result of analyzing the unit data. In some implementations, the qualification model may comprise a binary classification model. In some implementations, the qualification model may be trained in a manner similar to the manner described below in connection with FIG. 2. For example, the qualification model may be trained using historical data (e.g., historical unit data).

In some implementations, the request may be received from a device (e.g., the user device, the counterfactual explanation analysis system, and/or another device) and the request may include the unit data. The unit data may include first data associated with a first unit of the group of units, second data associated with a second unit of the group of units, and so on. The first data may include information identifying the first unit, information identifying features of the first unit, and feature values of the features of the first unit. The second data may include information identifying the second unit, information identifying features of the second unit, and feature values of the features of the second unit, and so on.

As shown in FIG. 1B, for example, the first data may include information identifying the first unit (e.g., unit A), information identifying features of the first unit (e.g., a first feature of usage, a second feature of capability, and a third feature of age), and feature values of the features of the first unit (e.g., 4000 hours, 3 GHz, and 1 month). As shown in FIG. 1B, for example, the second data may include information identifying the second unit (e.g., unit B), information identifying features of the second unit (e.g., the first feature of usage, the second feature of capability, and the third feature of age), and feature values of the features of the second unit (e.g., 2000 hours, 500 MHz, and 4 months).

The qualification model may analyze the unit data to determine whether individual units qualify for the outcome. The qualification model may determine, predict, and/or indicate whether a unit is qualified for the outcome, according to a qualification threshold. In some implementations, the qualification threshold may be based on a combination of feature value thresholds (e.g., a first feature value threshold for a first feature, a second feature value threshold for a second feature, and so on). The qualification model may determine that the unit is qualified for the outcome when a combination of the features values, of the features of the unit, satisfy the combination of feature value thresholds. For instance, the qualification model may determine, predict, and/or indicate whether a unit is qualified for the outcome when the feature values of the unit satisfy the qualification threshold (e.g., the feature value of the first feature satisfies the first feature value threshold, the feature value of the second feature satisfies the second feature value threshold, and so on). In some implementations, the qualification threshold may be included in the request. In some implementations, the qualification may be determined (e.g., by the qualification model) based on historical data (e.g., historical qualification thresholds and/or historical unit data).

In some implementations, the qualification model may determine and/or indicate a confidence score associated with a prediction of whether the unit is qualified. The confidence score may correspond to a probability that the unit is qualified or is not qualified. In some implementations, the qualification model may determine a counterfactual explanation when the unit does not qualify for the outcome according to the qualification threshold and provide the counterfactual explanation as part of the qualification output. The qualification model may determine the counterfactual explanation when one or more of the feature values, of the features of the unit, do not correspond to (or are not associated with) one or more target feature values (or one or more target values) associated with the qualification threshold (e.g., a feature value that does not match the target feature value, that does not match the target feature value within a threshold degree of similarity (e.g., does not match within X %), that does not fall within a range of values for the target feature value, among other examples). For example, the qualification model may determine the counterfactual explanation when a first feature value (of a first feature of the unit) does not correspond to a first target feature value (e.g., associated with the first feature value threshold), when a second feature value (of a first feature of the unit) does not satisfy a second target feature value (e.g., associated with the second feature value threshold), and so on. In some implementations, the one or more target feature values may be included in target data that is received (e.g., with the user preferences).

As shown in FIG. 1B, assume that the first target feature value is 3000 hours or less, that the second target feature value is 2 GHz or more, and that the third target feature value is 3 or less. As shown in FIG. 1B, the qualification model may determine that unit A does not qualify for the outcome because the feature value of the first feature of unit A does not correspond to the first target feature value (or does not satisfy the first feature threshold). In such instance, the qualification model may determine and provide a counterfactual explanation CE_A indicating that unit A would qualify for the outcome if the feature value of the first feature of unit A was 3000 hours or less.

Similarly, the qualification model may determine that unit B does not qualify for the outcome because the feature value of the second feature of unit B does not correspond to the second target feature value (or does not meet the second feature threshold) and the feature value of the third feature of unit B does not correspond to the third target feature value (or does not meet the third feature threshold). In such instance, the qualification model may determine and provide a counterfactual explanation CE_B indicating that unit B would qualify for the outcome if the feature value of the second feature of unit B was 2 GHz or more and if the feature value of the third feature of unit B was 3 or less (e.g., with respect to the third unit). In some instances, when the qualification model determines that a particular unit qualifies for the outcome (e.g., when feature values of features of the particular unit satisfy the qualification threshold), the qualification model may not determine and provide a counterfactual explanation.

The qualification model may generate the qualification output based on analyzing the unit data, as described above. The qualification output may include (e.g., for one or more units of the group of units) information identifying the one or more units, information indicating whether the one or more units qualify for the outcome (hereinafter qualification information), and information regarding a counterfactual explanation (hereinafter counterfactual information) for the one or more units in the event the one or more units do not qualify for the outcome.

In some implementations, the qualification model may be configured to provide the qualification output (e.g., to the counterfactual explanation analysis system) based on a trigger (e.g., based on a request from the counterfactual explanation analysis system and/or based on generating a counterfactual explanation for a unit). Additionally, or alternatively, the qualification model may be configured to provide the qualification output (e.g., to the counterfactual explanation analysis system) periodically (e.g., every minute, every hour, every day, and/or according to another time schedule). In some implementations, the qualification model may be configured to provide the unit data along with the qualification output.

As shown in FIG. 1B, and by reference 120 number, the counterfactual explanation analysis system may receive the qualification output, the unit data, and user preferences relating to the qualification output. For example, the counterfactual explanation analysis system may receive the qualification output from the qualification model, may receive the unit data from the group data structure, and receive the user preferences from the user device. In some implementations, the counterfactual explanation analysis system may receive a request to determine a group counterfactual explanation for the group of units and may obtain the qualification output, the unit data, and the user preferences based on the request. In some implementations, the request may include information identifying a portion or a percentage of the group of units that corresponds to a majority of the group of units (e.g., to which the group counterfactual explanation is to be applicable).

In some implementations, the counterfactual explanation analysis system may receive the qualification output from the qualification model, in a manner similar to the manner described above. In some implementations, the qualification model may be configured to transmit the unit data along with the counterfactual explanations.

In some implementations, the counterfactual explanation analysis system may receive, from the group data structure, the unit data based on receiving the request to determine the group counterfactual explanation. For example, the counterfactual explanation analysis system may identify (e.g., in the request) information identifying the group of units and may use the information identifying the group of units to perform a lookup in the group data structure to obtain the unit data.

In some implementations, the request may be received from the user device and the request may include the user preferences. The user preferences may be related to a manner in which the qualification output is to be analyzed in order to determine the group counterfactual explanation. In some implementations, the request may be received from a device other than the user device (e.g., a device of an administrator associated with the counterfactual explanation analysis system) and the request may include the user preferences (related to a manner in which the qualification output is to be analyzed).

The user preferences may include information relating to altering feature values of one or more features (of units of the group of units). The information relating to altering feature values (hereinafter referred to feature information) may identify a manner in which the feature values are to be altered for the purpose of determining the group counterfactual explanation. The feature information may correspond to one or more constraints that are used to determine the group counterfactual explanation.

The feature information may include information identifying one or more features that are to be altered, information identifying an order for altering the feature values of the one or more features (e.g., alter a feature value of the first feature, then alter a feature value of a second feature, and so on), information identifying a manner to alter the features (e.g., increase or decrease a feature value based on a fixed value and/or based on a range of values), information identifying a quantity of iterations relating to altering the feature values, information identifying one or more features whose values are not to be altered (e.g., because such alteration may be infeasible, complex, and/or time consuming). The feature information may enable the counterfactual explanation analysis system to preserve computing resources, network resources, and/or other resources that would have otherwise been used to perform a large of number of iterations (with respect to altering the feature values) until the group counterfactual explanation is determined.

As shown in FIG. 1C, and by reference 130 number, the counterfactual explanation analysis system may analyze the qualification output to identify the counterfactual explanations. For example, the counterfactual explanation analysis system may analyze the qualification output to identify the counterfactual explanations determined for the group of units. As shown in FIG. 1C, the counterfactual explanations determined for the groups of units may include a first counterfactual explanation (e.g., CE_A) determined for the first unit (e.g., unit A), a second counterfactual explanation (e.g., CE_B) determined for the second unit (e.g., unit B), and so on.

As shown in FIG. 1C, and by reference number 140, the counterfactual explanation analysis system may identify features with feature values to be altered based on the counterfactual explanations. For example, the counterfactual explanation analysis system may analyze the counterfactual explanations (determined for the group of units) and may identify features of the group of units with feature values that were recommended, in the counterfactual explanations, to be altered (e.g., in order for a respective unit to qualify for the outcome).

For example, as shown in FIG. 1C, the counterfactual explanation analysis system may determine that the first counterfactual explanation recommended that the features value (of the first feature of the first unit) be altered. Similarly, the counterfactual explanation analysis system may determine that the second counterfactual explanation recommended that the feature values (of the second feature and the third feature of the second unit) be altered, and so on. In other words, the counterfactual explanation analysis system may determine that the counterfactual explanations (determined for the group of units) have identified the first feature, the second feature, and the third feature (of the units of the group of units) as features with feature values to be altered. Accordingly, the counterfactual explanation analysis system may identify the first feature, the second feature, and the third feature (of the units of the group of units) as features to be altered.

As shown in FIG. 1D, and by reference number 150, the counterfactual explanation analysis system may select a feature, alter feature values of the feature, determine counterfactual explanations, and determine an impact score. For example, after identifying the features to be altered, the counterfactual explanation analysis system may select a feature from the features to be altered. In some implementations, the counterfactual explanation analysis system may select the feature based on a user input (e.g., included in the user preferences). For example, the user input may indicate an order (or a priority) based on which a feature may be selected out of the features. For instance, the order may indicate that the second feature is to be selected first, the third feature is to be selected second, the first feature is to be selected third, and so on. The above order is merely provided as an example, and other examples may differ from what is described above.

Additionally, or alternatively, to selecting a feature based on the user input, the counterfactual explanation analysis system may select the feature based on a distribution of feature values of a feature. For example, the counterfactual explanation analysis system may analyze the feature values of the features identified above to determine a distribution of feature values for the features (e.g., a distribution of feature values for the first feature, a distribution of feature values for the second feature, and so on). The counterfactual explanation analysis system may order (or prioritize) the features based on the distribution of feature values and may select a feature associated with a smallest distribution of feature values (e.g., relatively same feature values) out of the distributions of feature values of the features.

Additionally, or alternatively, to selecting a feature based on the distribution of feature values, the counterfactual explanation analysis system may select the feature based on an average of feature values of a feature. For example, the counterfactual explanation analysis system may analyze the feature values of the features to determine an average of feature values for the features (e.g., an average of feature values for the first feature, an average of feature values for the second feature, and so on). The counterfactual explanation analysis system may order (or prioritize) the features based on the average of feature values and may select a feature associated with a smallest average of feature values out of the averages of feature values of the features.

Additionally, or alternatively, to selecting a feature based on the average of feature values, the counterfactual explanation analysis system may select the feature based on a range of feature values of a feature. For example, the counterfactual explanation analysis system may analyze the feature values of the features to determine a range of feature values for the features (e.g., a range of feature values for the first feature, a range of feature values for the second feature, and so on). The counterfactual explanation analysis system may order (or prioritize) the one or more features based on the range of feature values and may select a feature associated with a smallest range of feature values out of the ranges of feature values of the one or more features.

In some implementations, the user input, the distribution of values, the average of values, and/or the range of values may be part of a scheme (e.g., a priority scheme) based on which a feature may be selected out of the features to be altered. Assume that, based on the scheme, the counterfactual explanation analysis system selects the second feature (out of the features to be altered) as a first feature to be altered. The counterfactual explanation analysis system may alter the feature values for the second feature of one or more units of the group of units. In some implementations, by altering the feature values, the counterfactual explanation analysis system may generate one or more revised counterfactual explanation constraints.

In some implementations, the counterfactual explanation analysis system may identify the one or more units. For example, the counterfactual explanation analysis system may analyze the counterfactual explanations to identify the one or more units with feature values, for the second feature, that are to be altered. For instance, the counterfactual explanation analysis system may analyze the counterfactual explanations to identify the one or more units with feature values, for the second feature, that do not satisfy the second target feature value. The counterfactual explanation analysis system may alter the feature values of the one or more units.

In some implementations, the counterfactual explanation analysis system may alter the feature values for the second feature of the one or more units based on the one or more constraints described above. For example, the counterfactual explanation analysis system may alter the feature value based on the information identifying the manner to alter the features (e.g., increase or decrease a feature value based on a fixed value, based on a range of values, and/or based on a measure of deviation with respect to the feature value of the second feature and/or with respect to the second target feature value).

In some implementations, the feature values of the second feature of the one or more units may be altered to correspond to the second target feature value in various manners. For example, the feature values of the second feature of the one or more units may be altered to a same value for the second feature. Alternatively, the feature values of the second feature of the one or more units may be altered by both being increased or by both being decreased within a range of values associated with the second target feature value.

As shown in FIG. 1D, assume, for example, that the counterfactual explanation analysis system identifies the second unit as having a feature value that does not satisfy the second target feature value. The counterfactual explanation analysis system may alter the feature value for the second feature of the second unit. For example, as shown in FIG. 1D, the feature value of the second feature of the second unit may be altered by being increased to 2 GHz.

The counterfactual explanation analysis system may use the qualification model to determine whether the second unit qualifies for the outcome based on the altered feature value of the second feature, in a manner similar to the manner described above. For example, the counterfactual explanation analysis system may generate revised unit data, for the second unit, that includes the altered feature value for the second feature of the second unit. The qualification model may analyze the revised unit data to determine an output identifying a revised counterfactual explanation for the second unit. As shown in FIG. 1D, the output may identify the revised counterfactual explanation (e.g., CE_D) which indicates that the second unit does not satisfy the qualification threshold (e.g., because the feature value, of the third feature, does not correspond to the third target feature value). In some implementations, one or more revised counterfactual explanations may be obtained based on one or more revised counterfactual explanation constraints.

The counterfactual explanation analysis system may determine the impact score associated with the second feature (e.g., associated with the altered feature values of the second feature). The impact score may correspond to a percentage (or a portion) of the units, of the group of units, that satisfies the qualification threshold (e.g., after the feature values, of the second feature, have been altered for the one or more units). The counterfactual explanation analysis system may determine the impact score and determine whether the impact score satisfy an impact threshold.

The impact threshold may correspond to a minimum percentage (or portion) of the units of the group of units that satisfy the qualification threshold based on altering feature values of a selected feature (in this example, the second feature). In some implementations, the impact threshold may be determined by the counterfactual explanation analysis system, by the user device, and/or by another device. In some implementations, the impact threshold may be determined based on the feature information. For example, the feature information may include information identifying the minimum percentage of the group of units discussed above. In such instance, the counterfactual explanation analysis system may set the impact threshold to the minimum percentage of the group of units. Additionally, or alternatively, to determining the impact threshold based on the feature information, the impact threshold may be determined based on historical data (e.g., historical impact thresholds, historical feature information, and/or historical unit data). Additionally, or alternatively, the impact threshold may be a pre-configured value (e.g., identified by an administrator of the counterfactual explanation analysis system).

The counterfactual explanation analysis system may generate the group counterfactual explanation when the impact score satisfies the impact threshold. Alternatively, the counterfactual explanation analysis system may reiterate the actions described in connection with reference number 150 when the impact score does not satisfy the impact score.

As shown in FIG. 1D, and by reference number 160, the counterfactual explanation analysis system may iterate until the impact score, associated with the altered feature values of the selected feature, satisfy the impact threshold. For example, if the counterfactual explanation analysis system determines that the impact score does not satisfy the impact threshold, the counterfactual explanation analysis system may reiterate the actions described above in connection with reference number 150. In some implementations, the counterfactual explanation analysis system may select a feature (e.g., a next feature out of the features identified to be altered) based on the scheme described above. For example, the counterfactual explanation analysis system may select a next highest priority feature based on the priority scheme described above. For instance, the counterfactual explanation analysis system may select the third feature which has been identified as the next highest priority feature according to the priority scheme.

The counterfactual explanation analysis system may identify one or more units with features values, of the third feature, that are altered and may alter the feature values of the third feature of the one or more units, in a manner similar to the manner described above. As an example, the counterfactual explanation analysis system may decrease the feature values (of the third feature of the one or more units) to correspond the third target feature value. The counterfactual explanation analysis system may determine an impact score associated with the altered feature values of the third feature, in a manner similar to the manner described above. The counterfactual explanation analysis system may determine whether the impact score satisfies the impact threshold, in a manner similar to the manner described above. The counterfactual explanation analysis system may iterate the actions described above until the counterfactual explanation analysis system determines an impact score (e.g., associated with altering one or more feature values of a selected feature) that satisfies the impact threshold.

In some implementations, if the counterfactual explanation analysis system determines that the impact score (e.g., associated with altering one or more feature values of a selected feature) satisfies the impact threshold, the counterfactual explanation analysis system may determine the group counterfactual explanation based on the altered one or more feature values of the selected feature. For example, the counterfactual explanation analysis system may include, in the group counterfactual explanation, information identifying the selected feature, information identifying the altered one or more feature values, and a recommendation for a value of the second feature to correspond to the altered one or more feature values.

The group counterfactual explanation may enable a majority of the group of units to qualify for the outcome, thereby preserving computing resources, network resources, and/or communication resources that would have otherwise been used to generate a counterfactual explanation (for a group) that is applicable to only a portion the group and/or that would have otherwise been used to generate one or more additional counterfactual explanations for one or more other portions of the group.

As shown in FIG. 1D, assume that, during an iteration, the counterfactual explanation analysis system has selected the first feature and has identified the first unit and the third unit as units whose feature values are to be altered for the first feature. Further assume that the counterfactual explanation analysis system has altered the feature values of the first feature of the first unit and of the third unit to 3000 hours (e.g., based on the first target feature value). Further assume that the counterfactual explanation analysis system has determined an impact score associated with the altered feature values of the first feature). The counterfactual explanation analysis system may determine that the impact score satisfies the impact threshold because the first unit and the third unit qualify for the outcome based on the altered feature values of the first feature and because the first unit and the third unit are a majority of the group of units. The counterfactual explanation analysis system may determine a group counterfactual explanation based on the altered feature values of the first feature, as described above.

In some implementations, the counterfactual explanation analysis system may perform the iterations based on the counterfactual explanation analysis system and/or the qualification model implementing an algorithm. The algorithm may iteratively analyze (or search) counterfactual explanations of individual units of the group of units, identify features of the individual units of the group of units, and adjust feature values of the features until the algorithm identifies adjusted features that cause a majority of the group of units to qualify for the outcome. In some implementations, the counterfactual explanation analysis system may provide, as an input to the algorithm, the unit data and the user preferences. The algorithm may generate, as an output, the group counterfactual explanation.

In some implementations, the algorithm may include and/or may be based on an estimation distribution algorithm. Additionally, or alternatively, the algorithm may include and/or may be based on a learning classifier system and/or particle swarm optimization. In some implementations, the algorithm may be implemented as a machine learning model that is trained in a manner similar to the manner described below in connection with FIG. 2. For example, the machine learning model may be trained using historical data (e.g., historical unit data, historical counterfactual explanations associated with the unit data, historical constraints, and/or historical group counterfactual explanations). In some implementations, the counterfactual explanation analysis system may select multiple features and may alter feature values of the multiple features in a manner similar to the manner described above.

In some implementations, during one or more iterations, the counterfactual explanation analysis system may select multiple features and may alter feature values of the multiple features, in a manner similar to the manner described. In this regard, if an impact score (associated with altering the feature values of the multiple features) satisfy the impact threshold, the group counterfactual explanation may include information identifying the selected multiple features, information identifying the altered feature values of the selected multiple features, and a recommendation for values of the multiple features to correspond to the altered feature values.

As shown in FIG. 1E, and by reference 170 number, the counterfactual explanation analysis system may analyze units, in the group data structure, based on the feature and the associated feature value identified during the iterative process described above. For example, assume that the counterfactual explanation analysis system identifies a selected feature and an identified feature value (of the selected feature) associated with an impact score that satisfies the impact threshold. The counterfactual explanation analysis system may search the group data structure to identify one or more first units having the selected feature with a feature value that does not correspond to the identified feature value (e.g., a feature value that does not match the identified feature value, that does not match the identified feature value within a threshold degree of similarity (e.g., does not match within X %), that does not fall within a range of values for the identified feature value, among other examples). For instance, and continuing with the example described above in connection with reference number 160, the selected feature may be the first feature (e.g., usage) and the identified feature value may be 3000 hours. In this regard, the one or more first units may correspond to units with an amount of usage that exceeds 3000 hours.

The counterfactual explanation analysis system may generate information (e.g., a report) that identifies the selected feature (e.g., the first feature), that identifies the identified feature value (e.g., 3000 hours or less), and/or that indicates that the one or more first units are one or more units having the selected feature with a feature value that does not correspond to the identified feature value. The report may be provided to the user device to cause the user device to take one or more first actions regarding the one or more first units, as described below. In some implementations, the report may include information identifying the one or more first actions.

As shown in FIG. 1E, and by reference 180 number, the counterfactual explanation analysis system may identify available units associated with the feature value. For example, the counterfactual explanation analysis system may search the data structure associated with the resource information server to identify, from the available units, a subset of the available units that are associated with the selected feature with the identified feature value. For instance, and continuing with the example described above in connection with reference number 160, the subset of the available units may correspond to available units with an amount of usage that does not exceed 3000 hours. The counterfactual explanation analysis system may generate information associated with the subset of the available units and may provide, to the user device, the information associated with the subset of the available units to cause the user device to take one or more second actions regarding the subset of the available units, as described below.

The information associated with the subset of the available units may include information identifying one or more available units (of the subset of the available units), information indicating that the one or more available units are same as or similar to the group of units, information identifying the selected feature (e.g., the first feature), information identifying the identified feature value (e.g., 3000 hours), information indicating that the one or more available units are qualified for the outcome (e.g., the one or more available units have the selected feature with a feature value corresponding to the identified feature value), and/or information identifying the one or more second actions.

As shown in FIG. 1E, and by reference number 190, the counterfactual explanation analysis system may provide information associated with the selected feature. For example, the counterfactual explanation analysis system may provide the report to cause the user device to take the one or more first actions regarding the one or more first units. In some implementations, the one or more first actions may include causing the one or more first units to be disconnected from the network, causing the one or more first units to be suspended from providing network services associated with the network, causing the one or more first units to be configured to provide network services associated with another network, and/or updating the data structure (of the resource information server) to indicate that the one or more first units are available.

In some implementations, the counterfactual explanation analysis system may perform the one or more first actions (e.g., perform the one or more first actions in their entirety or perform a first portion of the one or more first actions in conjunction with the user device performing a second portion of the one or more first actions). In some implementations, the report may cause the one or more first units to be removed from consideration with respect to the outcome (e.g., removed from consideration with respect to being qualified to be included in the network). By providing the report, the counterfactual explanation analysis system may preserve computing resources and/or network resources that would have otherwise been used to consider the one or more first units for the outcome.

In some implementations, the counterfactual explanation analysis system may provide (to the user device) the information associated with the subset of the available units to cause the user device to take the one or more second actions regarding the subset of the available units. In some implementations, the one or more second actions may include causing units (of subset of the available units) to power up, causing the units to be configured to provide the networking services, and/or causing the units to be connected to the network to provide the networking services.

In some implementations, the counterfactual explanation analysis system may perform the one or more second actions (e.g., perform the one or more second actions in their entirety or perform a first portion of the one or more second actions in conjunction with the user device performing a second portion of the one or more second actions). In some implementations, the information may cause the user device to identify one or more units of the subset of the available units that may replace one or more units, of the group of units, that did not satisfy the qualification threshold.

By generating the group counterfactual explanation, by providing the report, and/or by providing the information associated with the subset of the available units, the counterfactual explanation analysis system may preserve computing resources, network resources, and/or communication resources that would have otherwise been used to generate a counterfactual explanation (for a group) that is applicable to only a portion the group and/or that would have otherwise been used to generate one or more additional counterfactual explanations for one or more other portions of the group.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

FIG. 2 is a diagram illustrating an example 200 of training and using a machine learning model in connection with generating a counterfactual explanation associated with a group. The machine learning model training and usage described herein may be performed using a machine learning system. The machine learning system may include or may be included in a computing device, a server, a cloud computing environment, or the like, such as the counterfactual explanation analysis system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the counterfactual explanation analysis system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the counterfactual explanation analysis system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of usage, a second feature of capability, a third feature of age, and so on. As shown, for a first observation, the first feature may have a value of “4000 hours,” the second feature may have a value of “3 GHz,” the third feature may have a value of “1,” and so on. These features and feature values are provided as examples, and may differ in other examples. For example, the feature set may include one or more of the following features: make, manufacturer, model, memory, and/or storage.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is counterfactual explanation, which has a value of “reduce hours” for the first observation.

The feature set and target variable described above are provided as examples, and other examples may differ from what is described above. For example, for a target variable of group counterfactual explanation, the feature set may include information identifying groups of units, counterfactual explanations for individual units of the group, features of the individual units, and constraints for the features.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of “6000 hours,” a second feature of “2 GHz,” a third feature of “2,” and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “reduce hours” for the target variable of counterfactual explanation for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, the unit would qualify if the unit had less usage hours. The first automated action may include, for example, identifying a unit with similar capability and with less usage hours.

As another example, if the machine learning system were to predict a value of “increase capability,” for the target variable of counterfactual explanation, then the machine learning system may provide a second (e.g., different) recommendation (e.g., the unit would qualify if a capability of the unit was increased) and/or may perform or cause performance of a second (e.g., different) automated action (e.g., identifying a unit with similar age and with increased capability).

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations and actions described above are provided as examples, and other examples may differ from what is described above.

In this way, the machine learning system may apply a rigorous and automated process to identify a counterfactual explanation associated with a group. The machine learning system enables recognition and/or identification of tens, hundreds, thousands, or millions of features and/or feature values for tens, hundreds, thousands, or millions of observations, thereby increasing accuracy and consistency and reducing delay associated with identifying a counterfactual explanation associated with a group relative to requiring computing resources to be allocated for tens, hundreds, or thousands of operators to manually identify a counterfactual explanation associated with a group using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a counterfactual explanation analysis system 301 (which may correspond to the counterfactual explanation analysis system described above), which may include one or more elements of and/or may execute within a cloud computing system 302. The cloud computing system 302 may include one or more elements 303-313, as described in more detail below. As further shown in FIG. 3, environment 300 may include a network 320, a user device 330 (which may correspond to the user device described above), and/or a resource information server 340 (which may correspond to the resource information server described above). Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

Although the counterfactual explanation analysis system 301 may include one or more elements 303-313 of the cloud computing system 302, may execute within the cloud computing system 302, and/or may be hosted within the cloud computing system 302, in some implementations, the counterfactual explanation analysis system 301 may not be cloud-based (e.g., may be implemented outside of a cloud computing system) or may be partially cloud-based. For example, the counterfactual explanation analysis system 301 may include one or more devices that are not part of the cloud computing system 302, such as device 400 of FIG. 4, which may include a standalone server or another type of computing device. The counterfactual explanation analysis system 301 may perform one or more operations and/or processes described in more detail elsewhere herein.

Network 320 includes one or more wired and/or wireless networks. For example, network 320 may include a cellular network, a public land mobile network (PLMN), a local area network (LAN), a wide area network (WAN), a private network, the Internet, and/or the like, and/or a combination of these or other types of networks. The network 320 enables communication among the devices of environment 300.

The user device 330 may include one or more devices capable of communicating with a counterfactual explanation analysis system (e.g., counterfactual explanation analysis system 301) and/or a network (e.g., network 320). For example, the user device 330 may include a wireless communication device, an IoT device, a radiotelephone, a personal communications system (PCS) terminal (e.g., that may combine a cellular radiotelephone with data processing and data communications capabilities), a smart phone, a laptop computer, a laptop computer, a tablet computer, a personal gaming system, and/or a similar device.

The reference information server 340 may include one or more devices capable of communicating with a counterfactual explanation analysis system (e.g., counterfactual explanation analysis system 301) and/or a network (e.g., network 320). The reference information server 340 may provide information regarding availability of units. In some implementations, the information regarding availability of units may be stored in a data structure associated with the resource information server 340.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of one or more devices of FIGS. 3 and 4. The example components may be example components of a device 400, which may correspond to the counterfactual explanation analysis system 301, the user device 330, and/or the reference information server 340. In some implementations, the counterfactual explanation analysis system 301, the user device 330, and/or the reference information server 340 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

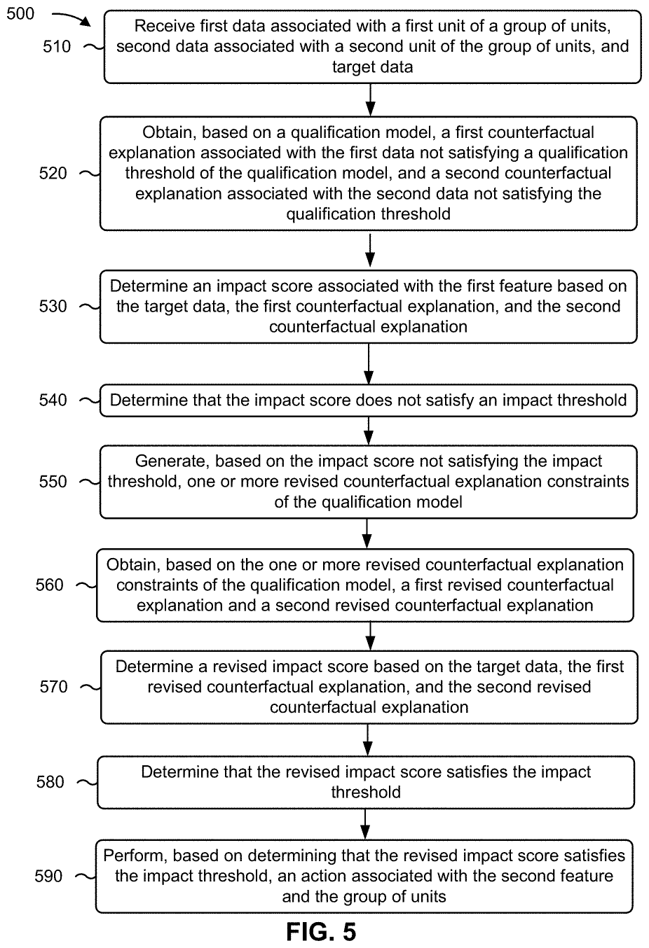

FIG. 5 is a flowchart of an example process 500 associated with determining a counterfactual explanation associated with a group. In some implementations, one or more process blocks of FIG. 5 may be performed by a device (e.g., the counterfactual explanation analysis system 301). In some implementations, one or more process blocks of FIG. 5 may be performed by another device or a group of devices separate from or including the device, such as a user device (e.g., the user device 330) and/or a reference information server (e.g., the reference information server 340). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving first data associated with a first unit of a group of units, second data associated with a second unit of the group of units, and target data (block 510). For example, the device may receive first data associated with a first unit of a group of units, second data associated with a second unit of the group of units, and target data, as described above.

As further shown in FIG. 5, process 500 may include obtaining, based on a qualification model, a first counterfactual explanation associated with the first data not satisfying a qualification threshold of the qualification model, and a second counterfactual explanation associated with the second data not satisfying the qualification threshold, wherein the first counterfactual explanation and the second counterfactual explanation are associated with a first feature identified in the first data and the second data (block 520). For example, the device may obtain, based on a qualification model, a first counterfactual explanation associated with the first data not satisfying a qualification threshold of the qualification model, and a second counterfactual explanation associated with the second data not satisfying the qualification threshold, wherein the first counterfactual explanation and the second counterfactual explanation are associated with a first feature identified in the first data and the second data, as described above. In some implementations, the first counterfactual explanation and the second counterfactual explanation are associated with a first feature identified in the first data and the second data, as described above.

In some implementations, the qualification model is preconfigured to determining, based on received data, whether units of the group or units of another group that is associated with the group are qualified according to the qualification threshold, and providing counterfactual explanations for units that do not qualify according to the qualification threshold. In some implementations, the qualification model is preconfigured to: determine, based on received data, whether the units of the group, or units of another group that is associated with the group, are qualified according to the qualification threshold; and provide counterfactual explanations for certain units that do not qualify according to the qualification threshold.

In some implementations, the first counterfactual explanation and the second counterfactual explanation are associated with a first feature identified in the first data and the second data. In some implementations, the first counterfactual explanation is obtained based on the first data not identifying a first target value for the first feature that is associated with the first data satisfying the qualification threshold, and wherein the second counterfactual explanation is obtained based on the second data not identifying a second target value for the first feature that is associated with the second data satisfying the qualification threshold.

As further shown in FIG. 5, process 500 may include determining an impact score associated with the first feature based on the target data, the first counterfactual explanation, and the second counterfactual explanation (block 530). For example, the device may determine an impact score associated with the first feature based on the target data, the first counterfactual explanation, and the second counterfactual explanation, as described above.

As further shown in FIG. 5, process 500 may include determining that the impact score does not satisfy an impact threshold (block 540). For example, the device may determine that the impact score does not satisfy an impact threshold, as described above.

As further shown in FIG. 5, process 500 may include generating, based on the impact score not satisfying the impact threshold, one or more revised counterfactual explanation constraints of the qualification model (block 550). For example, the device may generate, based on the impact score not satisfying the impact threshold, one or more revised counterfactual explanation constraints of the qualification model, as described above, as described above.

In some implementations, the second feature is selected from a plurality of features associated with individual units of the group based on at least one of a user input, a distribution of values of the second feature associated with the individual units of the group, an average of values of the second feature associated with the individual units of the group, or a range of values of the second feature associated with the individual units of the group.

As further shown in FIG. 5, process 500 may include obtaining, based on the one or more revised counterfactual explanation constraints of the qualification model, a first revised counterfactual explanation and a second revised counterfactual explanation (block 560). For example, the device may obtain, based on the one or more revised counterfactual explanation constraints of the qualification model, a first revised counterfactual explanation and a second revised counterfactual explanation, as described above.

As further shown in FIG. 5, process 500 may include determining a revised impact score based on the target data, the first revised counterfactual explanation, and the second revised counterfactual explanation (block 570). For example, the device may determine a revised impact score based on the target data, the first revised counterfactual explanation, and the second revised counterfactual explanation, as described above.

As further shown in FIG. 5, process 500 may include determining that the revised impact score satisfies the impact threshold (block 580). For example, the device may determine that the revised impact score satisfies the impact threshold, as described above.

As further shown in FIG. 5, process 500 may include performing, based on determining that the revised impact score satisfies the impact threshold, an action associated with the second feature and the group of units (block 590). For example, the device may perform, based on determining that the revised impact score satisfies the impact threshold, an action associated with the second feature and the group of units, as described above.

In some implementations, performing the action comprises identifying, from a plurality of available units in a separate group from the group, a subset of the plurality of available units that are associated with a feature value that is associated with the revised first data or the revised second data, and providing, to a user device, information associated with the subset of the plurality of available units.

In some implementations, performing the action comprises generating a report that identifies the second feature and a feature value for the second feature, wherein the feature value is associated with at least one of the first revised data or the second revised data, and providing, to a user device, the report in association with an indication of individual units in the group that are not associated with the feature value of the second feature.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, first data associated with a first unit of a group of units, second data associated with a second unit of the group of units, and target data;
obtaining, by the device and based on a qualification model, a first counterfactual explanation associated with the first data not satisfying a qualification threshold of the qualification model, and a second counterfactual explanation associated with the second data not satisfying the qualification threshold,
wherein the first counterfactual explanation and the second counterfactual explanation are associated with a first feature identified in the first data and the second data;
determining, by the device, an impact score associated with the first feature based on the target data, the first counterfactual explanation, and the second counterfactual explanation;
determining, by the device, that the impact score does not satisfy an impact threshold;
generating, by the device and based on the impact score not satisfying the impact threshold, one or more revised counterfactual explanation constraints of the qualification model;
obtaining, by the device and based on the one or more revised counterfactual explanation constraints of the qualification model, a first revised counterfactual explanation and a second revised counterfactual explanation;
determining, by the device, a revised impact score based on the target data, the first revised counterfactual explanation, and the second revised counterfactual explanation;
determining, by the device, that the revised impact score satisfies the impact threshold; and
performing, by the device and based on determining that the revised impact score satisfies the impact threshold, an action associated with the second feature and the group of units.

2. The method of claim 1, wherein obtaining the first revised counterfactual explanation and the second revised counterfactual explanation comprises:
generating revised first data by altering a first value of a second feature within the first data;
generating revised second data by altering a second value of the second feature within the second data; and
obtaining the first revised counterfactual explanation and the second revised counterfactual explanation based on the revised first data and the revised second data,
wherein the first value and the second value are altered to a same value for the second feature.

3. The method of claim 1, wherein obtaining the first revised counterfactual explanation and the second revised counterfactual explanation comprises:
generating revised first data by altering a first value of a second feature within the first data;
generating revised second data by altering a second value of the second feature within the second data; and
obtaining the first revised counterfactual explanation and the second revised counterfactual explanation based on the revised first data and the revised second data,
wherein the first value and the second value are altered by being increased or by both being decreased.

4. The method of claim 1, wherein the qualification model is preconfigured to:
determine, based on received data, whether units of the group or units of another group that is associated with the group are qualified according to the qualification threshold; and
provide counterfactual explanations for units that do not qualify according to the qualification threshold.

5. The method of claim 1, wherein the first counterfactual explanation is obtained based on the first data not identifying a first target value, associated with the target data, for the first feature that is associated with the first data satisfying the qualification threshold, and
wherein the second counterfactual explanation is obtained based on the second data not identifying a second target value, associated with the target data, for the first feature that is associated with the second data satisfying the qualification threshold.

6. The method of claim 1, wherein obtaining the first revised counterfactual explanation and the second revised counterfactual explanation comprises:
generating revised first data by altering a first value of a second feature within the first data;
generating revised second data by altering a second value of the second feature within the second data; and
obtaining the first revised counterfactual explanation and the second revised counterfactual explanation based on the revised first data and the revised second data; and
wherein the second feature is selected from a plurality of features associated with individual units of the group of units based on at least one of:
a user input;
a distribution of values of the second feature associated with the individual units of the group;
an average of values of the second feature associated with the individual units of the group; or
a range of values of the second feature associated with the individual units of the group.

7. The method of claim 1, wherein performing the action comprises:
identifying, from a plurality of available units in a separate group from the group of units, a subset of the plurality of available units that are associated with a feature value that is associated with the revised first data or the revised second data; and
providing, to a user device, information associated with the subset of the plurality of available units.

8. The method of claim 1, wherein obtaining the first revised counterfactual explanation and the second revised counterfactual explanation comprises:
generating revised first data by altering a first value of a second feature within the first data;
generating revised second data by altering a second value of the second feature within the second data; and
obtaining the first revised counterfactual explanation and the second revised counterfactual explanation based on the revised first data and the revised second data; and
wherein performing the action comprises:
generating a report that identifies the second feature and a feature value for the second feature,
wherein the feature value is associated with at least one of the first revised data or the second revised data; and
providing, to a user device, the report in association with an indication of individual units in the group of units that are not associated with the feature value of the second feature.

9. A device, comprising:
one or more memories; and
one or more processors, communicatively coupled to the one or more memories, configured to:
receive data associated with units of a group,
wherein, for a unit, a subset of the data includes values for features of the unit and a counterfactual explanation associated with the unit not satisfying a qualification threshold of a qualification model;
determine, based on the data, that a subset of units of the group are associated with a same counterfactual explanation;
alter feature values, of the subsets of the units, for a feature that is associated with the counterfactual explanation to generate revised subsets of the data with revised feature values;
process, based on the qualification model, the revised subsets of the data to obtain revised counterfactual explanations associated with the subsets of the units;
determine an impact score associated with the feature based on a quantity of units, of the subset of units, that satisfy the qualification threshold based on the revised subsets of the data;
determine that the impact score satisfies an impact threshold; and
provide, to a user device, information identifying that the revised feature values cause the quantity of units to satisfy the qualification threshold of the qualification model.

10. The device of claim 9, wherein the impact threshold corresponds to a minimum percentage of the units of the group that satisfy the qualification threshold based on altering corresponding feature values of the feature.

11. The device of claim 9, wherein the feature is selected for altering the values according to a priority scheme that is based on a least one of:
a user input;
a distribution of values of the feature associated with the units of the group;
an average of values of the feature associated with the units of the group; or
a range of values of the feature associated with the units of the group.

12. The device of claim 9, wherein the qualification model is preconfigured to:
determine, based on received data, whether the units of the group, or units of another group that is associated with the group, are qualified according to the qualification threshold; and
provide counterfactual explanations for certain units that do not qualify according to the qualification threshold.

13. The device of claim 9, wherein the one or more processors are further configured to:
determine, based on the revised feature values, a target feature value for the feature; and
provide, to a user device, information identifying units of the group that are not associated with the target feature value.

14. The device of claim 9, wherein the one or more processors are further configured to:
determine, based on the revised feature values, a target feature value for the feature;
identify, from a plurality of available units in a separate group from the group, a subset of the plurality of available units that are associated with the target feature value; and
provide, to a user device, information associated with the subset of the plurality of available units.

15. A non-transitory computer-readable medium storing a set of instructions, the set of instructions comprising:
one or more instructions that, when executed by one or more processors of a device, cause the device to:
receive data associated with units of a group,
wherein, for a unit, a subset of the data includes values for features of the unit and an indication of whether the subset of the data indicates that the unit satisfies a qualification threshold of a qualification model;
identify subsets of the data associated with a subset of units of the group that indicate that the subsets of units do not satisfy the qualification threshold according to the qualification model;
alter feature values, of the subsets of the units, for a feature to generate revised subsets of the data with revised feature values;
process, based on the qualification model, the revised subsets of the data to obtain counterfactual explanations associated with the subsets of the units;
determine an impact score associated with the feature based on a quantity of units, of the subset of units, that satisfied the qualification threshold based on the revised subsets of the data;
determine that the impact score satisfies an impact threshold; and
perform an action associated with the feature and the group.

16. The non-transitory computer-readable medium of claim 15, wherein the subsets of the data are identified based on being associated with counterfactual explanations associated with one or more of the features.

17. The non-transitory computer-readable medium of claim 15, wherein the one or more instructions, further cause the device to:
prior to altering the feature values, select the feature, from a plurality of features, based on a priority scheme associated with one or more characteristics of the plurality of features.

18. The non-transitory computer-readable medium of claim 15, wherein the qualification model comprises a binary classification model.

19. The non-transitory computer-readable medium of claim 15, wherein the one or more instructions, that cause the device to perform the action, cause the device to:
determine, based on the revised feature values, a target feature value for the feature; and
provide, to a user device, information identifying units of the group that are not associated with the target feature value.

20. The non-transitory computer-readable medium of claim 15, wherein the one or more instructions, that cause the device to perform the action, cause the device to:
determine, based on the revised feature values, a target feature value for the feature;
identify, from a plurality of available units in a separate group from the group, a subset of the plurality of available units that are associated with the target feature value; and
provide, to a user device, information associated with the subset of the plurality of available units.
